(19) United States
(12) Patent Application Publication
(10) Pub. No.: US 2026/0053155 A1
(43) Pub. Date: Feb. 26, 2026

(54) Cooling Tabletop Display Assembly

(71) Applicant: Myra Zomer, Harrisburg, SD (US)

(72) Inventor: Myra Zomer, Harrisburg, SD (US)

(21) Appl. No.: 18/814,536

(22) Filed: Aug. 25, 2024

(51) Int. Cl. A23B 7/04; B65D 1/34; B65D 81/18; B65D 81/38; B65D 85/34

(52) U.S. Cl. CPC A23B 7/0425; B65D 1/34; B65D 81/18; B65D 81/3813; B65D 85/34

(57) ABSTRACT

A cooling tabletop display assembly for displaying fresh produce includes a receptacle and a cooling system. The receptacle includes a bottom portion and a perimeter wall extending upwardly from the bottom portion to define an interior space for retaining fresh produce in the receptacle. The perimeter wall has an upper edge that defines an opening extending into the interior space. The cooling system is operatively connected to the receptacle to lower a temperature of an upper surface of the bottom portion of the receptacle and thereby cool fresh produce therein to inhibit ripening and decomposition.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tabletop or countertop displays and more particularly pertains to a new cooling tabletop display assembly for displaying fresh produce, specifically fruits and vegetables, that includes a receptacle and a cooling system connected to the receptacle to lower the temperature of an upper surface portion of the receptacle and thereby cool fresh produce therein to inhibit ripening and decomposition of the fresh produce.

It is common to place fresh produce in receptacles or containers, such as bowls, trays, and baskets, on tabletops or countertops to store and display the fresh produce, both for consumption and decorative or presentation purposes. For example, a person may place fruits, such as apples, peaches, and nectarines, in a bowl to allow the fruit to ripen at room temperature and be available for consumption. As another example, a person may place a variety of fruits and vegetables on a tray that are arranged to create an aesthetic or decorative effect, such as for a dinner party or other social event, whether indoors or outdoors. One of the drawbacks of such displays is that the produce may ripen and/or decompose at a faster rate than would be desirable, thereby potentially wasting the produce or harming the aesthetics. As is well known, for most fruits and vegetables, lower temperatures, i.e., refrigeration, slow down the natural processes that lead to ripening and eventual decay. For fruits and vegetables, the chemical processes that cause plants to grow and ripen also cause them to rot, so refrigeration helps save the plant tissue from itself and slow the aging process. In addition, cold temperatures interfere with the growth of microorganisms that harm food, such as bacteria, mold, and yeast, which need a favorable temperature to grow. The cooling tabletop display assembly is designed to provide a cooling effect or refrigeration to preserve fresh produce to maintain the freshness and aesthetic beauty of fresh produce for a longer period of time.

### (2) Description of Related Art Including Information Disclosed Under 37 CFR 1.97 and 1.98

The prior art relates to cooling containers, chests, or shelves and plates. The prior art, as best understood, does not disclose a cooling tabletop display assembly for displaying fresh produce that includes a receptacle, such as a bowl, tray, or basket, that includes a bottom portion and a perimeter wall extending upwardly from the bottom portion to define an interior space, and a cooling system, wherein the cooling system is operatively connected to the receptacle to lower a temperature of an upper surface of the bottom portion of the receptacle and thereby cool fresh produce therein to inhibit ripening and decomposition.

### BRIEF SUMMARY OF THE INVENTION

An embodiment of the disclosure meets the needs presented above in a cooling tabletop display assembly generally comprising a receptacle and a cooling system. The receptacle includes a bottom portion and a perimeter wall extending upwardly from the bottom portion to define an interior space for retaining fresh produce in the receptacle. The perimeter wall has an upper edge that defines an opening extending into the interior space. The cooling system is operatively connected to the receptacle to lower a temperature of an upper surface of the bottom portion of the receptacle and thereby cool fresh produce therein to inhibit ripening and decomposition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cooling tabletop display assembly according to an embodiment of the disclosure.

FIG. 2 is a top view of an embodiment of the disclosure.

FIG. 3 is a bottom view of an embodiment of the disclosure.

FIG. 4 is a cross-sectional view of an embodiment of the disclosure.

FIG. 5 is a perspective view of a first alternative embodiment of the disclosure.

FIG. 6 is a top view of the first alternative embodiment of the disclosure.

FIG. 7 is a side view of a second alternative embodiment of the disclosure.

### DETAILED DESCRIPTION OF THE INVENTION

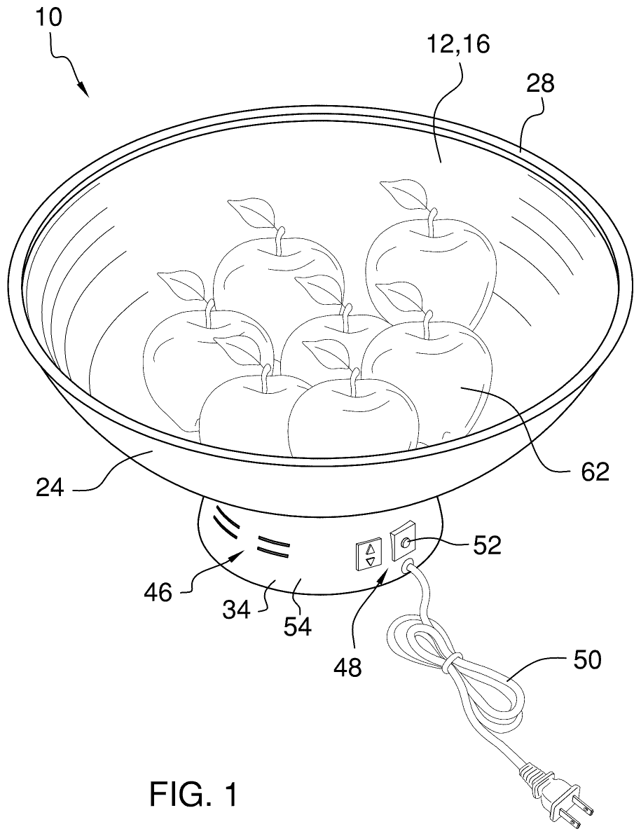

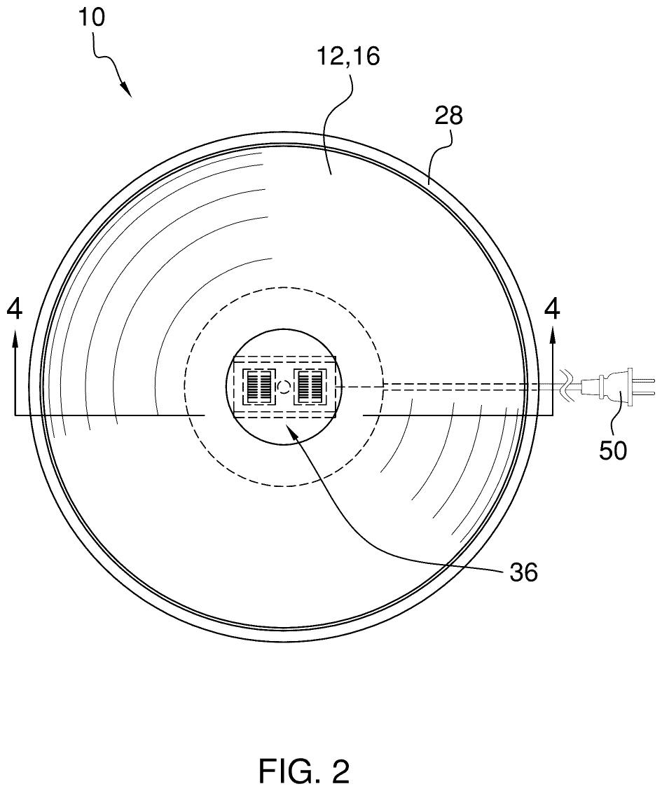

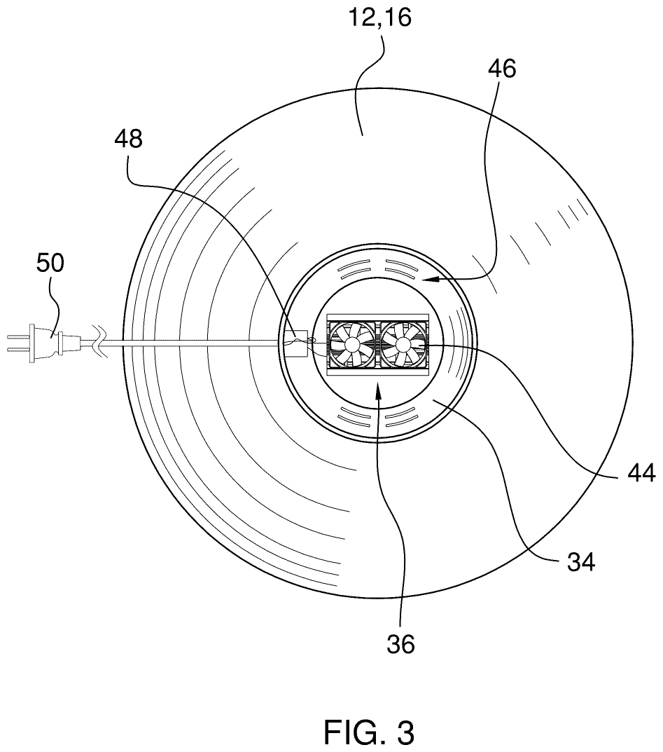

With reference now to the drawings, and in particular to FIGS. 1 through 7 thereof, a new cooling tabletop display assembly embodying the principles and concepts of an embodiment of the disclosure and generally designated by the reference numeral 10 will be described.

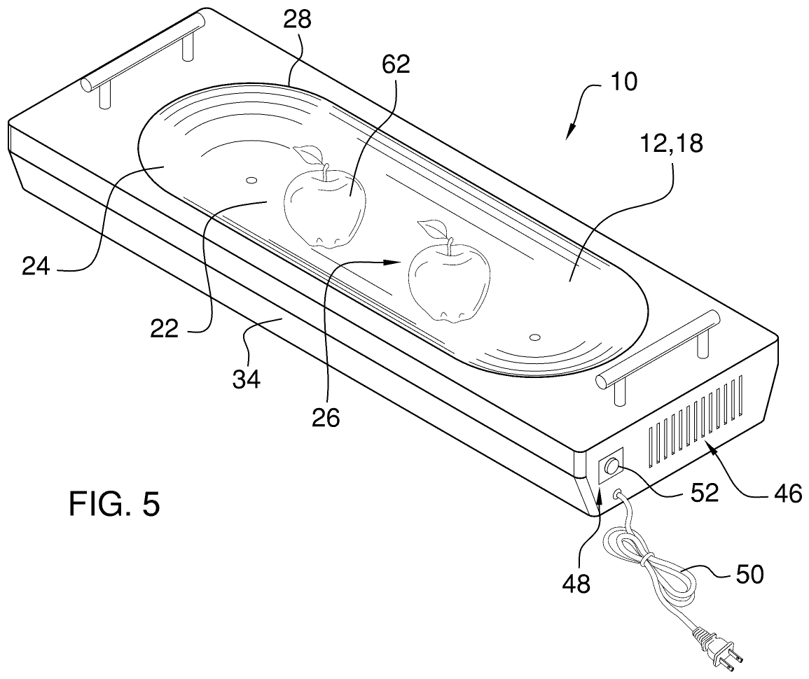

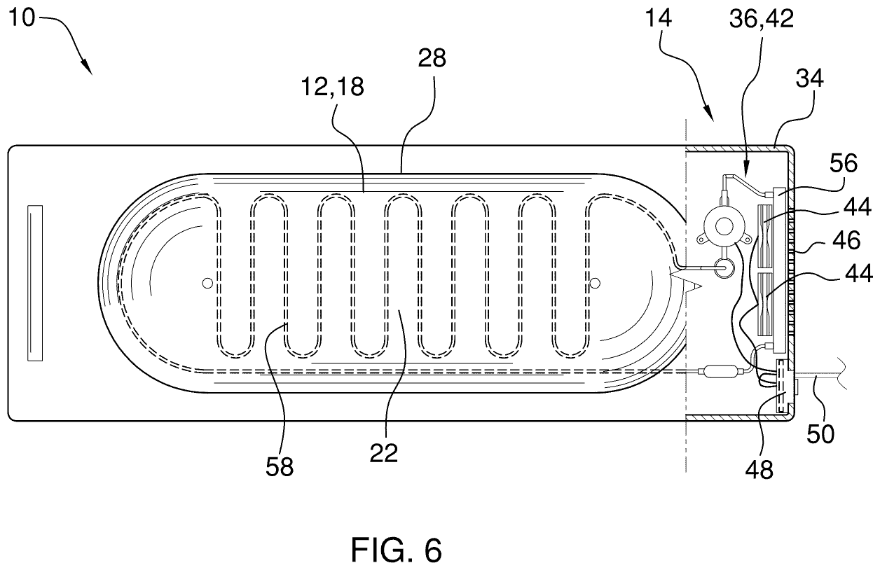

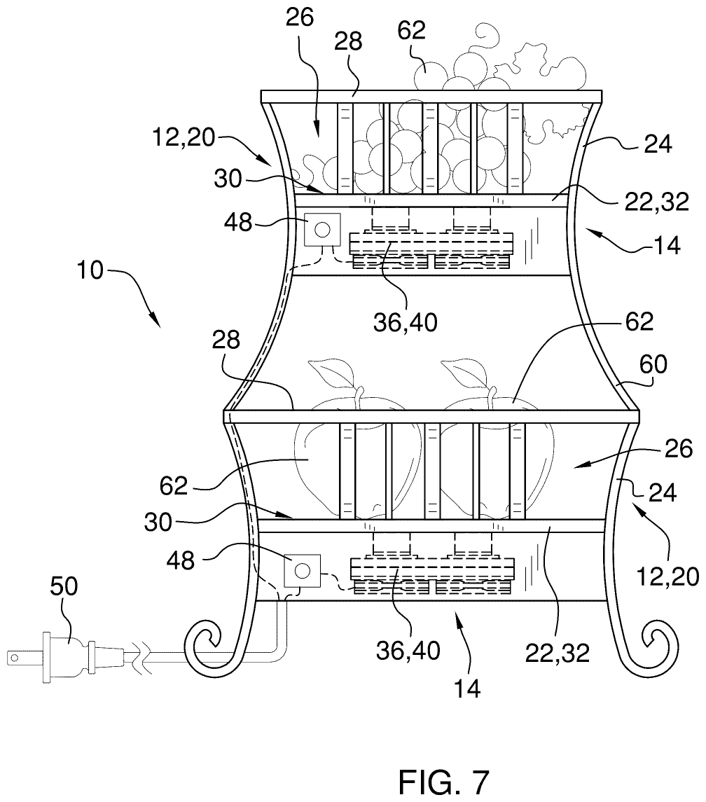

As best illustrated in FIGS. 1 through 7, the cooling tabletop display assembly 10 generally comprises a receptacle 12 and a cooling system 14. Before discussing the cooling tabletop display assembly 10 in detail, it should first be noted that FIGS. 1 through 4 show an exemplary embodiment of the cooling tabletop display assembly 10 where the receptacle 12 is in the form of a bowl 16, FIGS. 5 and 6 show a first alternative exemplary embodiment of the cooling tabletop display assembly 10 where the receptacle 12 is in the form of a tray 18, and FIG. 7 shows a second alternative exemplary embodiment of the cooling tabletop display assembly 10 where the receptacle 12 is in the form of a basket 20. These are exemplary embodiments, and components of each exemplary embodiment may be incorporated or adapted for use in the other exemplary embodiments. In addition, the description of the components of one embodiment may be applicable to similar or equivalent components of the other embodiments. Therefore, while the majority of the description will be with reference to the exemplary embodiment in FIGS. 1 through 4, it is also applicable to the alternative designs in the exemplary embodiments in FIGS. 5 through 7.

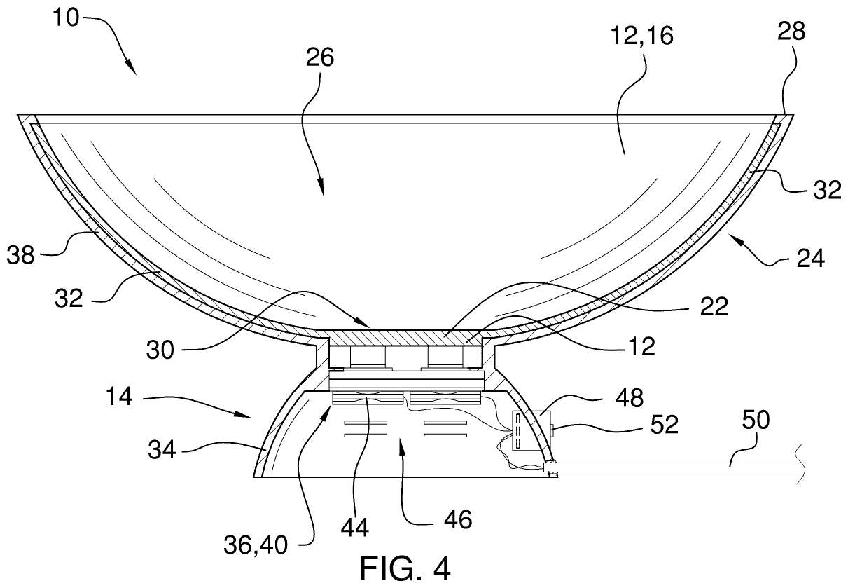

With reference FIG. 1 showing the exemplary embodiment where the receptacle 12 is in the form of the bowl 16, the receptacle 12 includes a bottom portion 22 and a perimeter wall 24 extending upwardly from the bottom portion 22 to define an interior space 26 for retaining fresh produce in the receptacle 12. The perimeter wall 24 has an upper edge 28 that defines an opening extending into the interior space 26. The cooling system 14 is operatively connected to the receptacle 12 to lower a temperature of an upper surface 30 of the bottom portion 22 of the receptacle 12 and thereby cool fresh produce therein to inhibit ripening and decomposition. As shown in FIG. 4, the bottom portion 22 includes a layer of thermally conductive material 32. In the exemplary embodiment shown in FIG. 4, the perimeter wall 24 also includes a layer of thermally conductive material 32, in this case integrally formed with the layer of thermally conductive material 32 of the bottom portion 22, to permit lowering of a temperature of an interior surface of the perimeter wall 24. This design allows the cooling effect to be produced not only at the bottom portion 22, but also at the perimeter wall 24, though the cooling at the bottom portion 22, in one possible embodiment, is sufficient to produce the desired cooling effect. Alternatively, the layer of thermally conductive material 32 of the bottom portion 22 and the layer of thermally conductive material 32 can be separate from one another, such as by being spaced apart or formed from different materials. The layer of thermally conductive material 32 could be metal, which metal, in one possible embodiment, could be covered with a coating that mimics plastic or woodgrain for aesthetic purposes, or that has non-stick or anti-microbial characteristics for maintaining hygienic conditions and to protect the fresh produce from contamination.

As shown in FIG. 4, the cooling system 14 includes a housing 34 connected to the receptacle 12 and a cooling unit 36 positioned in the housing 34. The housing 34 can be designed to support the receptacle 12, such as in FIG. 1 where the housing 34 is essentially a stand or similar on which the bowl 16 is supported. As shown in FIG. 4, the housing 34 can be integrally formed with the perimeter wall 24. In one possible embodiment, the housing 34 and an outer layer 38 of the perimeter wall 24 can comprise a thermally insulating material to help maintain cooler temperatures in the interior space 26. In another possible embodiment, only the outer layer 38 of the perimeter wall 24 is made of thermally insulating material. The housing 34 could be made of metal, wood, or plastic.

The cooling unit 36 can be of virtually any design suitable to produce a cooling effect, though the cooling unit 36 must be sufficiently small to fit into the restricted space provided by the housing 34. In the exemplary embodiment shown in FIG. 4, the cooling unit 36 is a thermoelectric unit 40, commonly referred to as a Peltier device. Alternatively, the cooling unit 36 could be a mini compressor unit 42, such as shown in FIGS. 5 and 6 as discussed further below. It should be noted that the cooling tabletop display assembly 10 is not limited to only the thermoelectric unit 40 or the mini compressor unit 42. Other cooling systems and technology suitable for small spaces could possibly be utilized or adapted for use in the cooling tabletop display assembly 10. For example, heat pipes are well-known heat-transfer devices commonly used for computer electronics like desktops, laptops, tablets, and smartphones, as well as other devices, such as home and kitchen appliances. Heat pipes have high heat transfer coefficients and thus are very efficient thermal conductors, even at very small sizes. One recent advancement in heat pipe technology is the use of nanoparticle layers or coatings on the interior surfaces of thin heat pipes to increase capillary action when used in conjunction with a nanofluid coolant, such as, for example, a suspension consisting of nanoparticles suspended in distilled water. Therefore, in one possible embodiment, the cooling unit 36 could be a heat pipe assembly, with or without nanoparticle layers.

Referring back to FIG. 4, the thermoelectric unit 40 functions in a known manner, wherein the thermoelectric unit 40 is positioned adjacent the bottom portion 22 to lower the temperature of the bottom portion 22. The cooling system 14 includes a fan 44, or multiple fans 44 as shown, and the housing 34 includes air vents 46, which are necessary to dissipate the heat generated by the thermoelectric unit 40, or by the mini compressor unit 42, as the case may be. As shown in FIGS. 1 and 4, the cooling system 14 includes a control unit 48 positioned on the housing 34 and a power cord 50 operatively connected to the cooling unit 36. The control unit 48 includes a power button 52 to turn the cooling unit 36 on and off. The control unit 48 also includes a temperature control 54 designed to permit a user to select a desired cooling temperature, though in one possible embodiment the temperature control 54 could be omitted and the cooling unit 36 designed to operate at a pre-set temperature. The adjustable temperatures could be in the range of about 40° F. to about 60° F., or about 4° C. to about 16° C., and the pre-set temperature could be selected from that range.

The design of the receptacle 12, as mentioned above, could be a bowl 16, a tray 18, or a basket 20, as well as other types of receptacles or containers suitable for displaying fresh produce. In FIGS. 1 through 4 showing the bowl 16, the perimeter wall 24 is solid and has a convex curvature such that the opening is wider than the bottom portion 22. The interior space 26 has a depth of about 1.0 to 12.0 inches, or possibly about 3.0 to 10.0 inches, or any other range common to bowls suitable for placement on tabletops or countertops.

In FIGS. 5 and 6 showing the tray 18, the perimeter wall 24 is solid and has a height substantially less than a length or width of the bottom portion 22 such that the receptacle 12 is shallow. The interior space 26 has a depth of about 1.0 to 3.0 inches, or any other range common to trays suitable for placement on tabletops or countertops. The housing 34 is much larger than in the embodiment of the bowl 16 in FIGS. 1 through 4, and the receptacle 12 is elongated and essentially is a trough or depression integrally formed in the housing 34. As seen in FIG. 6 and mentioned above, the cooling unit 36 is a mini compressor unit 42 connected to common components, such as a heat exchanger 56 and evaporator coils 58, which are positioned under the receptacle 12 in a snaking pattern.

In FIG. 7 showing the basket 20, the bottom portion 22 is solid and the perimeter wall 24 is designed as an open lattice, or essentially any design that has spaces or openings therein, such as a fence-like structure. The interior space 26 has a depth of about 1.0 to 12.0 inches, or possibly about 3.0 to 10.0 inches, or any other range common to baskets suitable for placement on tabletops or countertops. In the exemplary embodiment shown in FIG. 7, there are two receptacles 12 and a framework 60 supporting the receptacles 12. The cooling system 14 includes two cooling units 36, one for each of the two receptacles 12. While the basket 20 is shown in FIG. 7, the tiered design could be used with the bowl 16 or the tray 18.

As discussed above, the cooling tabletop display assembly 10 is designed to maintain fresh produce at a lower temperature similar to what may be present in a refrigerator or display case at a supermarket. The user plugs the cooling tabletop display assembly 10 into an electrical outlet and then presses the power button 52 to turn on the cooling unit 36. The cooling unit 36 then cools the bottom portion 22, as well as the perimeter wall 24, depending on the design, which in turn cools the fresh produce 62 placed in the receptacle 12. If the cooling tabletop display assembly 10 includes the temperature control 54, the user can select a temperature most suitable for the particular fruits and vegetables, or most suitable for the ambient temperature.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooling tabletop display assembly for displaying fresh produce comprising:
a receptacle comprising a bottom portion and a perimeter wall extending upwardly from said bottom portion to define an interior space for retaining fresh produce in said receptacle, said perimeter wall having an upper edge defining an opening extending into said interior space; and
a cooling system operatively connected to said receptacle to lower a temperature of an upper surface of said bottom portion of said receptacle and thereby cool fresh produce therein to inhibit ripening and decomposition.

2. The cooling tabletop display assembly of claim 1, wherein said bottom portion comprises a layer of thermally conductive material.

3. The cooling tabletop display assembly of claim 2, wherein said perimeter wall comprises a layer of thermally conductive material, either separate from or integrally formed with said layer of thermally conductive material of said bottom portion, to permit lowering of a temperature of an interior surface of said perimeter wall.

4. The cooling tabletop display assembly of claim 3, wherein said perimeter wall is solid and has a convex curvature such that said opening is wider than said bottom portion and said receptacle is in the form of a bowl.

5. The cooling tabletop display assembly of claim 3, wherein said perimeter wall is solid and has a height substantially less than a length or width of said bottom portion such that said receptacle is shallow and in the form of a tray.

6. The cooling tabletop display assembly of claim 2, wherein said perimeter wall is solid and has a convex curvature such that said opening is wider than said bottom portion and said receptacle is in the form of a bowl.

7. The cooling tabletop display assembly of claim 2, wherein said perimeter wall is solid and has a height substantially less than a length or width of said bottom portion such that said receptacle is shallow and in the form of a tray.

8. The cooling tabletop display assembly of claim 2, wherein said bottom portion is solid and said perimeter wall comprises an open lattice such that said receptacle is in the form of a basket.

9. The cooling tabletop display assembly of claim 2, wherein said cooling system comprises a housing connected to said receptacle and a cooling unit disposed in said housing.

10. The cooling tabletop display assembly of claim 9, wherein said cooling unit comprises one of a thermoelectric unit or a mini compressor unit.

11. The cooling tabletop display assembly of claim 9, wherein said housing supports said receptacle.

12. The cooling tabletop display assembly of claim 9, wherein said cooling system comprises a fan and said housing comprises air vents.

13. The cooling tabletop display assembly of claim 9, wherein said cooling system comprises a control unit disposed on said housing and a power cord operatively connected to said cooling unit.

14. The cooling tabletop display assembly of claim 13, wherein said control unit is configured to permit a user to select a desired cooling temperature.

15. The cooling tabletop display assembly of claim 1, wherein the cooling tabletop display assembly further comprises two receptacles and a framework supporting said receptacles, and said cooling system comprises two cooling units, one for each of said two receptacles.

16. A cooling tabletop display assembly for displaying fresh produce comprising:
a receptacle comprising a bottom portion and a perimeter wall extending upwardly from said bottom portion to define an interior space for retaining fresh produce in said receptacle, said perimeter wall having an upper edge defining an opening extending into said interior space, wherein said bottom portion comprises a layer of thermally conductive material; and
a cooling system operatively connected to said receptacle to lower a temperature of an upper surface of said bottom portion of said receptacle and thereby cool fresh produce therein to inhibit ripening and decomposition, wherein:
said cooling system comprises a housing connected to said receptacle and a cooling unit disposed in said housing;
said cooling unit comprises one of a thermoelectric unit or a mini compressor unit;
said housing supports said receptacle;
said cooling system comprises a fan and said housing comprises air vents;
said cooling system comprises a control unit disposed on said housing and a power cord operatively connected to said cooling unit; and
said control unit is configured to permit a user to select a desired cooling temperature.

17. The cooling tabletop display assembly of claim 16, wherein said perimeter wall comprises a layer of thermally conductive material, either separate from or integrally formed with said layer of thermally conductive material of said bottom portion, to permit lowering of a temperature of an interior surface of said perimeter wall.

18. The cooling tabletop display assembly of claim 16, wherein said perimeter wall is solid and has a convex curvature such that said opening is wider than said bottom portion and said receptacle is in the form of a bowl, and said interior space has a depth of about 1.0 to 12.0 inches.

19. The cooling tabletop display assembly of claim 16, wherein said perimeter wall is solid and has a height substantially less than a length or width of said bottom portion such that said receptacle is shallow and in the form of a tray, and said interior space has a depth of about 1.0 to 3.0 inches.

20. The cooling tabletop display assembly of claim 16, wherein said bottom portion is solid and said perimeter wall comprises an open lattice such that said receptacle is in the form of a basket, and said interior space has a depth of about 1.0 to 12.0 inches.
